(19) United States
(12) Patent Application Publication
(10) Pub. No.: US 2021/0242520 A1
(43) Pub. Date: Aug. 5, 2021

(54) LAMINATE BATTERY AND METHOD OF MANUFACTURING THE SAME

(71) Applicant: TOYOTA JIDOSHA KABUSHIKI KAISHA, Toyota-shi (JP)

(72) Inventors: Seigo FUJISHIMA, Miyoshi-shi (JP); Satoshi TABARA, Miyoshi-shi (JP)

(21) Appl. No.: 17/116,018

(22) Filed: Dec. 9, 2020

(30) Foreign Application Priority Data
Feb. 4, 2020 (JP) 2020-017429

(51) Int. Cl. H01M 50/103; H01M 10/0585; H01M 10/0525; H01M 50/557; H01M 50/133; B32B 37/06; B32B 27/06; B32B 3/26

(52) U.S. Cl. CPC H01M 50/103; H01M 10/0585; H01M 10/0525; H01M 50/557; B32B 2457/10; B32B 37/06; B32B 27/06; B32B 3/26; H01M 50/133

(57) ABSTRACT

A laminate battery includes an electrode body, an exterior body consisting of a pair of exterior films, and an electrode terminal. The exterior body has a film welded portion in which the exterior films are welded to each other, and a terminal welded portion in which the exterior films are welded to the electrode terminal. The electrode terminal is covered with a thermally weldable film, and the thermally weldable film has a protruding portion that protrudes from a side face of the electrode terminal outward in a depth direction. The length of the protruding portion is equal to or larger than 50% of the thickness of the terminal welded portion, and is smaller than 100% of the length of the film welded portion.

### CROSS-REFERENCE TO RELATED APPLICATION

This application claims priority to Japanese Patent Application No. 2020-017429 filed on Feb. 4, 2020, incorporated herein by reference in its entirety.

### BACKGROUND

### 1. Technical Field

The disclosure relates to a laminate battery and a method of manufacturing the laminate battery. More specifically, the disclosure relates to a laminate battery in which an electrode body is housed inside an exterior body made from laminate films.

### 2. Description of Related Art

In recent years, secondary batteries, such as lithium-ion secondary batteries, grow increasingly important as power sources for installation on vehicles, or power sources of personal computers and mobile terminals. In particular, lithium-ion secondary batteries, which are lightweight and have a high energy density, have been favorably used as high-power power sources for installation on vehicles. As one form of the secondary batteries of this type, a battery (which will also be called “laminate battery”) in which an electrode body is housed inside an exterior body made from laminate films is proposed. To construct the laminate battery, the electrode body is sandwiched between a pair of exterior films made of resin, and, in this condition, outer peripheral portions of the exterior films are pressurized and heated, to be welded together. In this manner, a bag-like exterior body having a welded portion in its outer peripheral portion is formed, and the electrode body is housed inside the exterior body.

The laminate battery includes plate-like electrode terminals for electrically connecting the electrode body inside the exterior body to an external device (such as another battery, or motor). One end portion of each electrode terminal is connected to the electrode body inside the exterior body, and the other end portion is exposed to the outside of the exterior body. Thus, the welded portion in the outer peripheral portion of the exterior body includes regions in each of which the electrode terminal is sandwiched between a pair of exterior films, and the exterior films are welded to the electrode terminal. In the following description, a welded portion in which the exterior films are welded to each other will be called “film welded portion”, and a welded portion in which the exterior films are welded to the electrode terminal will be called “terminal welded portion”.

In the terminal welded portion of the laminate battery, welding is performed between different materials, namely, a metal material (the electrode terminal) and a resin material (the exterior films); therefore, poor welding may appear at an interface between the electrode terminal and the exterior film. To cope with this situation, it has been proposed to interpose a thermally weldable film having favorable welding properties to both the metal material and resin material, between the electrode terminal and the exterior film. One example of this technology is disclosed in Japanese Unexamined Patent Application Publication No. 2005-243526 (JP 2005-243526 A), and another example is disclosed in Japanese Unexamined Patent Application Publication No. 2017-139121 (JP 2017-139121 A). For example, in a laminate battery described in JP 2005-243526 A, a tab (electrode terminal) is inserted through a flat, tubular, thermally weldable film obtained by looping a strip-shaped thermally weldable film into an annular shape, and squashing the film. When the thermally weldable film is attached to the electrode terminal, the thermally weldable film protrudes a given length from opposite side faces of the electrode terminal.

### SUMMARY

In the meantime, the terminal welded portion of the laminate battery is thicker than the film welded portion, by an amount corresponding to the thickness of the electrode terminal. Thus, a step is formed at the boundary between the terminal welded portion and the film welded portion formed in the welded portion. In a manufacturing site where mass production is conducted, some batteries may be produced in which a clearance is generated between the electrode terminal and the exterior film in the vicinity of the step. The batteries in which a clearance is generated in the welded portion are likely to suffer from deterioration of the performance due to entry of water into the exterior body, and volume expansion due to insufficient pressure reduction; therefore, such batteries need be discarded or corrected before shipping, which may cause reduction of the productivity. Thus, in recent years, it is considered to mount an elastic member to a pressing surface of a welding apparatus used for forming the welded portion, and deform the pressing surface so as to follow the step. However, there is a limit solely with the improvement of the welding apparatus, and batteries in which a clearance is generated in the vicinity of the step of the welded portion may still be produced.

This disclosure provides a laminate battery that can favorably prevent a clearance from being generated between an electrode terminal and an exterior film in the vicinity of a step of a welded portion of an exterior body, and a method of manufacturing the laminate battery.

Having studied a cause of generation of a clearance in the vicinity of the step of the welded portion, the inventor of this disclosure reached the following new finding.

Before describing the finding reached by the inventor, a procedure of forming a welded portion in a general laminate battery will be specifically described. FIG. 10 through FIG. 13 are cross-sectional views useful for describing a method of producing a known laminate battery. In the production of the laminate battery, a laminated body 100A is initially produced by laminating an electrode body (not shown) and exterior films. At this time, in an end portion (one side of an outer peripheral portion) of the laminated body 100A, an electrode terminal 130 is disposed between a pair of exterior films 122, 124, via thermally weldable films 140, as shown in FIG. 10. Then, the end portion of the laminated body 100A is placed between a pair of pressure plates P each having an elastic member P2 on its pressing surface, and the pressure plates P are moved toward each other. In FIG. 10, reference sign P1 denotes a base portion of the pressure plate P. Then, as shown in FIG. 11 to FIG. 13, the end portion of the laminated body 100A is pressurized and heated while the elastic members P2 are elastically deformed according to the shape of the electrode terminal 130. As a result, a welded portion W consisting of a film welded portion W1 and a terminal welded portion W2 is formed. At this time, if the exterior films 122, 124 are not deformed so as to follow the shape of the step D in the welded portion W, a clearance S is formed between the exterior film 122, 124 and the electrode terminal 130 in the vicinity of the step D.

The inventor considered the reason why the clearance S is formed in the vicinity of the step D of the welded portion W in the related art, as follows. When the welded portion starts being formed, as shown in FIG. 10, the pressure plates P (elastic members P2) initially contact the electrode terminal 130 via the exterior films 122, 124 and the thermally weldable films 140. At this time, the exterior films 122, 124 are sandwiched between the opposite end portions of the electrode terminal 130 and the pressure plates P, and first fixed points F1 are formed. Then, when the pressure plates P are moved toward each other while the elastic members P2 are elastically deformed, as shown in FIG. 11, the opposite end portions of the exterior films 122, 124 are sandwiched between the pressure plates P, and second fixed points F2 are formed. If the pressure plates P are further moved toward each other in this condition, strong tensile force is applied to the exterior films 122, 124 that are fixed at the first fixed points F1 and the second fixed points F2, as indicated by arrows A in FIG. 11 and FIG. 12. Thus, there is a possibility that the exterior films 122, 124 to which strong tensile force is applied cannot deform according to the step D at the boundary between the film welded portion W1 and the terminal welded portion W2. In this case, a clearance S is formed between the electrode terminal 130 and the exterior film 122, 124 in the vicinity of the step D.

On the basis of the above finding, the inventor found it possible to deform the exterior films 122, 124 in accordance with the step D, and prevent formation of the clearance S, if tensile force applied to the exterior films 122, 124 during formation of the welded portion W can be reduced. Then, as a means for reducing the tensile force, the inventor focused on the length L_{P} of a protruding portion 142 of the thermally weldable film 140. More specifically, when the pressure plates P are further moved toward each other, after formation of the first fixed points F1 and the second fixed points F2, as shown in FIG. 12, contact points C at which a distal end 142a of the protruding portion 142 contacts the pressure plates P via the exterior films 122, 124 are generated. The inventor assumed that, if the distal end 142a of the protruding portion 142 can be brought into contact with the pressure plates P, at substantially the same time as formation of the second fixed points F2 shown in FIG. 11, the contact points C provide third fixed points, which can disperse tensile force applied to the exterior films 122, 124 during formation of the welded portion W. Then, under this assumption, the inventor examined the length L_{P} of the protruding portion 142 of the thermally weldable film 140, and found, as a result of the examination, that, when the length L_{P} of the protruding portion 142 is equal to or larger than 50% of the thickness T_{E} of the terminal welded portion W2, the third fixed points are formed at substantially the same time as the second fixed points F2, and the clearance S is prevented from being formed in the vicinity of the step D.

A laminate battery according to a first aspect of the disclosure was developed based on the above finding. The laminate battery includes an electrode body, an exterior body having a pair of exterior films that are opposed to each other with the electrode body sandwiched between the exterior films, an electrode terminal having a plate shape, and having a first end portion connected to the electrode body and a second end portion exposed to the outside of the exterior body, as viewed in a width direction, and a thermally weldable film. The exterior body has a welded portion in an outer peripheral portion, and the welded portion includes a film welded portion in which the exterior films are welded to each other, and a terminal welded portion in which the exterior films are welded to the electrode terminal. A surface of the electrode terminal disposed between the exterior films in the welded portion is covered with the thermally weldable film, and the thermally weldable film has a protruding portion that protrudes from a side face of the electrode terminal outward in a depth direction. The length of the protruding portion of the thermally weldable film of the laminate battery is equal to or larger than 50% of the thickness of the terminal welded portion, and is smaller than 100% of the length of the film welded portion.

In the laminate battery according to the above aspect of the disclosure, the thermally weldable film is formed with the protruding portion that protrudes from a side face of the electrode terminal, and the length of the protruding portion is equal to or larger than 50% of the thickness of the terminal welded portion. With this arrangement, third fixed points at which the exterior films are sandwiched between the distal end of the protruding portion and the pressure plates are generated, in addition to the first fixed points and second fixed points as described above. With the three sets of fixed points thus formed on the exterior films during formation of the welded portion, tensile force applied to the exterior films can be dispersed and reduced; therefore, a clearance is prevented from being formed in the vicinity of a step at a boundary between the film welded portion and the terminal welded portion. If the length of the protruding portion of the thermally weldable film is too long in the laminate battery, the protruding portion is exposed to the outside of the exterior films, and the third fixed points will not be formed. Thus, the upper limit of the length of the protruding portion of the thermally weldable film in the laminate battery is set to be smaller than 100% of the length of the film welded portion.

In the laminate battery according to the above aspect of the disclosure, the thickness of the protruding portion may be equal to or larger than 20% and equal to or smaller than 50% of the thickness of the terminal welded portion. With this arrangement, the time at which the second fixed points are formed can be made further closer to the time at which the third fixed points are formed; therefore, tensile force applied to the exterior films during formation of the welded portion can be more favorably dispersed and reduced.

In the laminate battery according to the above aspect of the disclosure, the length of the protruding portion may be equal to or larger than 35% and equal to or smaller than 65% of the length of the film welded portion. With this arrangement, the time at which the second fixed points are formed can be made further closer to the time at which the third fixed points are formed; therefore, tensile force applied to the exterior films during formation of the welded portion can be more favorably dispersed and reduced.

In the laminate battery according to the above aspect of the disclosure, each of the exterior films may be a laminate film having a multi-layer structure including at least a resin layer opposed to the electrode body, and a metal layer formed on an outer side of the resin layer. With this arrangement, the strength of the exterior film is improved, and the laminate battery of a higher quality can be constructed.

In the laminate battery using the exterior films of the multi-layer structure including the metal layer, one end portion of the thermally weldable film as viewed in the width direction may be exposed to the outside of the exterior body. With this arrangement, the metal layer of the exterior film is prevented from being conductively connected to the electrode terminal.

Another aspect of the disclosure provides a method of manufacturing a laminate battery including an electrode body, an exterior body having a pair of exterior films that are opposed to each other with the electrode body sandwiched between the exterior films, an electrode terminal having a plate shape, and having a first end portion connected to the electrode body and a second end portion exposed to an outside of the exterior body, and a thermally weldable film that covers a surface of the electrode terminal disposed between the exterior films. The method of manufacture includes the steps of: forming a laminated body in which the electrode body to which the electrode terminal is connected is disposed between the exterior films, and the second end portion of the electrode terminal is exposed to an outside of the exterior films, while the surface of the electrode terminal disposed between the exterior films is covered with the thermally weldable film, placing an end portion of the laminated body in which the electrode terminal is interposed between the exterior films, between a pair of pressure plates, heating the pressure plates to a predetermined temperature, and forming a welded portion by sandwiching the end portion of the laminated body between the heated pressure plates, to pressurize and heat the end portion. The welded portion includes a film welded portion in which the exterior films are welded to each other, and a terminal welded portion in which the exterior films are welded to the electrode terminal. In the method of manufacture, the thermally weldable film has a protruding portion that protrudes from a side face of the electrode terminal in a depth direction, and the length of the protruding portion is equal to or larger than 50% of the thickness of the terminal welded portion, and is smaller than 100% of the length of the film welded portion.

As described above, in the method of manufacture according to the second aspect of the disclosure, the thermally weldable film is formed with the protruding portion having the length that is equal to or larger than 50% of the thickness of the terminal welded portion, and is smaller than 100% of the length of the film welded portion. Thus, the three sets of fixed points, i.e., the first, second, and third fixed points, are formed on the exterior films in the welding step, so that tensile force applied to the exterior films can be dispersed and reduced. Thus, according to the method of manufacture, a clearance is prevented from being formed between the exterior films and the electrode terminal, in the vicinity of a step at a boundary between the film welded portion and the terminal welded portion.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view schematically showing a laminate battery according to one embodiment of the disclosure;

FIG. 2 is a cross-sectional view as seen in a direction of arrows II-II in FIG. 1;

FIG. 3 is a plan view schematically showing an electrode terminal used in the laminate battery according to the embodiment of the disclosure;

FIG. 4 is a perspective view useful for describing a method of manufacturing the laminate battery according to the embodiment of the disclosure;

FIG. 5 is a cross-sectional view useful for describing the method of manufacturing the laminate battery according to the embodiment of the disclosure;

FIG. 6 is a cross-sectional view useful for describing the method of manufacturing the laminate battery according to the embodiment of the disclosure;

FIG. 7 is a cross-sectional view useful for describing the method of manufacturing the laminate battery according to the embodiment of the disclosure;

FIG. 8 is a cross-sectional view useful for describing the method of manufacturing the laminate battery according to the embodiment of the disclosure;

FIG. 9 is a cross-sectional view useful for describing the method of manufacturing the laminate battery according to the embodiment of the disclosure;

FIG. 10 is a cross-sectional view useful for describing a method of manufacturing a known laminate battery;

FIG. 11 is a cross-sectional view useful for describing the method of manufacturing the known laminate battery;

FIG. 12 is a cross-sectional view useful for describing the method of manufacturing the known laminate battery; and

FIG. 13 is a cross-sectional view useful for describing the method of manufacturing the known laminate battery.

### DETAILED DESCRIPTION OF EMBODIMENTS

One embodiment of the technologies disclosed herein will be described with reference to the drawings. Also, matters (e.g., the detailed structure and materials of an electrode body, and detailed structure of a welding apparatus) needed for implementing the disclosure, other than matters particularly mentioned in this specification, can be grasped as design matters conceived by those skilled in the art based on the related art in the field concerned.

In the drawings referred to in this specification, the same reference signs are assigned to members and portions that perform the same functions, for use in description of the members and portions. Also, dimensions (such as the length, width, and thickness) in the drawings do not reflect the actual dimensional relationships. In each drawing, reference sign “X” denotes “width direction”, and reference sign “Y” denotes “depth direction”, while reference sign “Z” denotes “height direction”. These directions are defined as such for the sake of illustration, and are not intended to restrict any of the technologies (e.g., the orientation of a laminate battery when produced and used) disclosed herein.

Laminate Battery

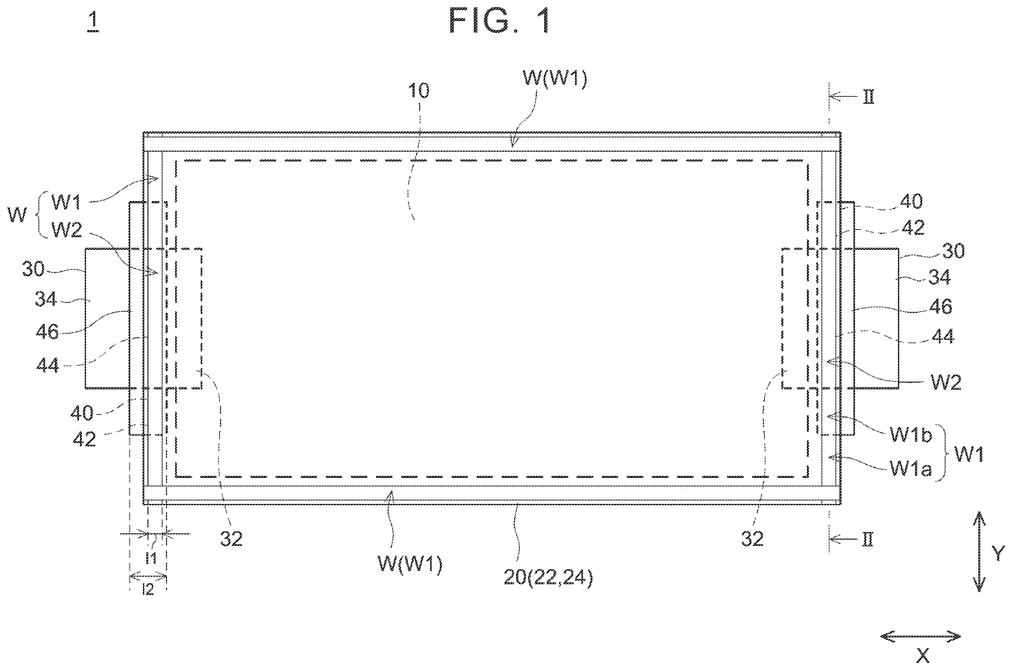

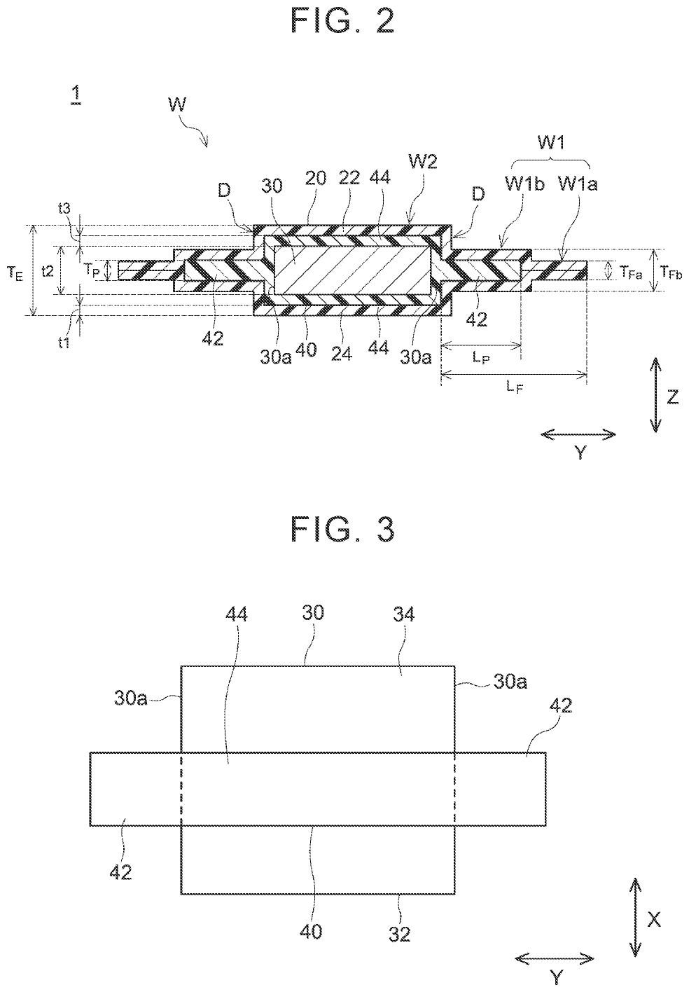

FIG. 1 is a plan view schematically showing a laminate battery according to this embodiment. FIG. 2 is a cross-sectional view as seen in a direction of arrows II-II in FIG. 1. FIG. 3 is a plan view schematically showing an electrode terminal used in the laminate battery according to this embodiment.

As shown in FIG. 1, the laminate battery 1 according to this embodiment includes an electrode body 10, exterior body 20 consisting of a pair of exterior films 22, 24, and electrode terminals 30 each having an end portion 34 exposed to the outside of the exterior body 20. In the laminate battery 1, a welded portion W is formed in an outer peripheral portion of the exterior body 20, and surfaces of the electrode terminals 30 located in the welded portion W are covered with thermally weldable films 40. Each component will be specifically described below.

Electrode Body

The electrode body 10 used in the laminate battery 1 according to this embodiment has a flat, rectangular profile. The detailed structure of the electrode body 10 is not particularly limited, but known structures may be used with no particular restriction. For example, the electrode body 10 may be a wound electrode body formed by winding long electrode sheets via separators. Also, the electrode body 10 may be a laminated electrode body in which a plurality of rectangular electrode sheets is laminated via separators. The structure and material of each of the members (such as electrode sheets and separators) that constitute the electrode body are also not particularly limited, but those that can be used in this type of secondary battery can be used with no particular restriction.

Exterior Body

The exterior body 20 is a bag-like battery case that is formed by welding outer peripheral portions of the exterior films 22, 24 (see FIG. 2) that are opposed to each other with the electrode body 10 sandwiched therebetween. The exterior films 22, 24 are laminate films each including an insulating resin layer. The resin layers of the exterior films 22, 24 are located so as to be opposed to the electrode body 10. The resin layer is formed of polypropylene, polyethylene, or polychloro trifluoro ethylene, for example. Although not illustrated in the drawings, each of the exterior films 22, 24 is preferably a laminate film having a multi-layer structure including a metal layer formed on the outer side of the resin layer, in addition to the resin layer opposed to the electrode body 10. Thus, the exterior body 20 having high strength can be formed, owing to the use of the laminate films of the multi-layer structure including the metal layers. The metal layer is formed of a material selected from aluminum, stainless steel, copper, and so forth. From the standpoint of improvement in the abrasion resistance of the exterior body 20, it is particularly preferable to use a laminate film having three or more layers in which a resin layer is further laminated on the outer side of the metal layer, among the laminate films of the multi-layer structure.

The thickness t1 of the exterior film 22, 24 is preferably equal to or larger than 30 μm, more preferably equal to or larger than 60 μm, further preferably equal to or larger than 90 μm, and is particularly preferably equal to or larger than 120 μm. It is thus possible to ensure sufficient strength of the exterior films 22, 24. Also, the upper limit of the thickness t1 of the exterior film 22, 24 is not particularly limited, but may be equal to or smaller than 500 μm, or may be equal to or smaller than 350 μm. Considering the conductivity of heat to the thermally weldable films 40 that will be described later, the upper limit of the thickness t1 of the exterior film 22, 24 is preferably equal to or smaller than 270 μm, more preferably equal to or smaller than 240 μm, further preferably equal to or smaller than 210 μm, and is particularly preferably equal to or smaller than 180 μm.

Electrode Terminal

The electrode terminal 30 is a conductive member that electrically connects the electrode body 10 with an external device. The electrode terminal 30 is formed of a conductive material, such as aluminum, copper, or nickel. As shown in FIG. 3, the electrode terminal 30 is a plate-like member having a given dimension in the width direction X. As shown in FIG. 1, one end portion 32 (closer to the middle) of the electrode terminal 30 as viewed in the width direction X is connected to the electrode body 10. The other (outer) end portion 34 is exposed to the outside of the exterior body 20. Although detailed description will not be provided, the electrode terminal 30 connected to the positive electrode side of the electrode body 10 provides a positive electrode terminal, and the electrode terminal 30 connected to the negative electrode side provides a negative electrode terminal.

The thickness t2 of the electrode terminal 30 shown in FIG. 2 is preferably equal to or larger than 50 μm, more preferably equal to or larger than 100 μm, further preferably equal to or larger than 200 μm, and is particularly preferably equal to or larger than 300 μm. Thus, the electric resistance of the electrode terminal 30 can be sufficiently reduced. Also, the upper limit of the thickness t2 of the electrode terminal 30 is not particularly limited, but may be equal to or smaller than 1500 μm, or may be equal to or smaller than 1000 μm. However, the upper limit of the thickness t2 of the electrode terminal 30 is preferably equal to or smaller than 800 μm, more preferably equal to or smaller than 700 μm, further preferably equal to or smaller than 600 μm, and is particularly preferably equal to or smaller than 500 μm. This leads to reduction of a step D at a boundary between a film welded portion W1 and a terminal welded portion W2, and the electrode terminal 30 and the exterior films 22, 24 can be easily welded to each other.

Welded Portion

As described above, in the laminate battery 1 according to this embodiment, the welded portion W is formed in the outer peripheral portion of the exterior body 20. The welded portion W consists of the film welded portions W1 and the terminal welded portions W2.

The film welded portion W1 is a portion where the exterior films 22, 24 are welded to each other. As shown in FIG. 1, the film welded portions W1 extend along the opposite side edges of the exterior body 20, and are also formed in parts of the opposite end portions as viewed in the width direction X. Typically, the parts are located on the opposite outer sides (in the depth direction Y) of the opposite end portions. As shown in FIG. 2, each of the film welded portions W1 formed in the opposite end portions as viewed in the width direction X consist of a first film welded portion W1a in which the pair of exterior films 22, 24 are directly welded to each other, and a second film welded portion W1b in which the exterior films 22, 24 are welded via a protruding portion 42 of the thermally weldable film 40. The thickness T_{Fa} of the first film welded portion W1a is substantially equal to the total thickness (t1×2) of the pair of exterior films 22, 24. Also, the thickness T_{Fb} of the second film welded portion W1b is substantially equal to the sum ((t1×2)+T_{P}) of the total thickness (t1×2) of the exterior films 22, 24, and the thickness (T_{P}) of the protruding portion 42 of the thermally weldable film 40.

On the other hand, in the terminal welded portion W2, the exterior films 22, 24 are welded to the electrode terminal 30. More specifically, in the terminal welded portion W2, the exterior films 22, 24 are welded to surfaces of the electrode terminal 30 via terminal covering portions 44 of the thermally weldable film 40. The terminal welded portions W2 are formed only in the opposite end portions of the exterior body 20 as viewed in the width direction X (see FIG. 1). As shown in FIG. 2, in each of the welded portions W formed in the opposite end portions as viewed in the width direction X, the terminal welded portion W2 is formed in a middle portion as viewed in the depth direction Y, and the second film welded portions W1b are formed on the opposite outer sides of the terminal welded portion W2, while the first film welded portions W1a are formed on the further outer sides of the second film welded portions W1b. The thickness T_{E} of the terminal welded portion W2 is substantially equal to the sum ((t1×2)+t2+(t3×2)) of the total thickness (t1×2) of the pair of exterior films 22, 24, the thickness (t2) of the electrode terminal 30, and the total thickness (t3×2) of the terminal covering portions 44 of the thermally weldable film 40.

Thermally Weldable Film

The thermally weldable film 40 is a resin member that covers the surfaces of the electrode terminal 30 placed between the exterior films 22, 24 in the welded portion W. With the intervention of the thermally weldable film 40, the electrode terminal 30 made of metal and the resin layers of the exterior films 22, 24 can be favorably welded to each other. As the material of the thermally weldable film 40, a resin material that is fused at substantially the same level of temperature as the exterior films 22, 24, and exhibits good welding properties to both the resin material and metal material, can be selected as appropriate. The selection of the material for the thermally weldable film 40 does not restrict the technologies disclosed herein. As one example, a film of a multi-layer structure including modified polypropylene, or a polyolefin layer can be used as the thermally weldable film 40.

A portion of the thermally weldable film 40 which covers a surface of the electrode terminal 30 will be called terminal covering portion 44. The thickness t3 of the terminal covering portion 44 is preferably equal to or larger than 40 μm, more preferably equal to or larger than 60 μm, further preferably equal to or larger than 80 μm, and is particularly preferably equal to or larger than 100 μm. Thus, the thermally weldable film 40 can favorably function as an intermediate layer when welding the electrode terminal 30 with each of the exterior films 22, 24. The upper limit of the thickness t3 of the terminal covering portion 44 is not particularly limited. However, if the thickness of the terminal covering portion 44 is too large, the terminal covering portion 44 may be insufficiently fused during formation of the welded portion W, which may result in poor welding. From this standpoint, the upper limit of the thickness t3 of the terminal covering portion 44 is preferably equal to or smaller than 350 μm, more preferably equal to or smaller than 300 μm, further preferably equal to or smaller than 250 μm, and is particularly preferably equal to or smaller than 200 μm.

The length l2 of the thermally weldable film 40 as measured in the width direction X shown in FIG. 1 is preferably set to be larger than the length l1 of the welded portion W as measured in the width direction X. With this arrangement, even when the positions of the respective members are shifted during formation of the welded portion W, the electrode terminal 30 and the exterior films 22, 24 can be welded via the thermally weldable film 40. More specifically, where the length l1 of the welded portion W in the width direction X is within a range of 4 mm to 6 mm, the length l2 of the thermally weldable film 40 in the width direction X is preferably equal to or larger than 7 mm, more preferably equal to or larger than 8 mm, further preferably equal to or larger than 9 mm, and is particularly preferably equal to or larger than 10 mm. Further, in the laminate battery 1 according to this embodiment, one end portion 46 of the thermally weldable film 40 as viewed in the width direction X is exposed to the outside of the exterior body 20. Thus, short-circuiting that would be caused by conduction between the metal layer of the exterior body 20 and the electrode terminal 30 can be prevented from occurring.

As shown in FIG. 2, the thermally weldable film 40 has a protruding portion 42 that protrudes toward the outer side in the depth direction Y, from each side face 30a of the electrode terminal 30. The laminate battery 1 according to this embodiment is characterized in that the length L_{P} of the protruding portion 42 of the thermally weldable film 40 is equal to or larger than 50% of the thickness T_{E} of the terminal welded portion W2, and is smaller than 100% of the length L_{F} of the film welded portion W1. With the protruding portion 42 formed with such a length, a clearance (see reference sign “S” in FIG. 13) is prevented from being generated between the electrode terminal 30 and each of the exterior films 22, 24, in the vicinity of the step D at the boundary between the film welded portion W1 and the terminal welded portion W2. The reason why this effect is obtained will be described with reference to a method of manufacturing the laminate battery according to this embodiment.

Method of Manufacturing Laminate Battery

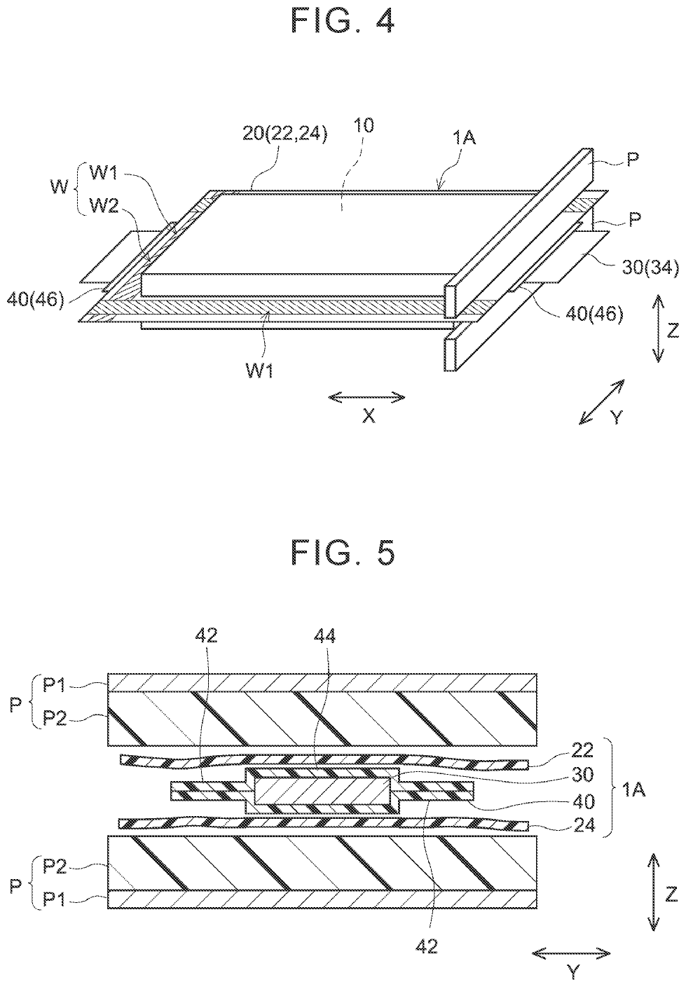

FIG. 4 is a perspective view schematically showing a method of manufacturing the laminate battery according to this embodiment. FIG. 5 through FIG. 9 are cross-sectional views useful for describing the method of manufacturing the laminate battery according to this embodiment.

Welding Apparatus

Initially, a welding apparatus used in the method of manufacture according to this embodiment will be described. As shown in FIG. 4, the welding apparatus includes a pair of pressure plates P. More specifically, each of the pressure plates P is a rectangular plate-like member that extends in the depth direction Y. The pressure plates P are positioned such that an upper face of the lower pressure plate P is opposed to a bottom of the upper pressure plate P, and one side of an outer peripheral portion of a laminated body 1A as a precursor of the laminate battery is located between the upper and lower pressure plates P.

As shown in FIG. 5, the pressure plate P includes an elastic member P2 on a pressing surface. More specifically, the pressure plate P includes a base portion P1 made of metal, and the elastic member P2 mounted on the pressing surface of the base portion P1. To form the base portion P1, a metal material having given thermal conductivity and strength is preferably used. The metal material is selected from, for example, iron, aluminum, chromium, nickel, and alloys thereof. On the other hand, the elastic member P2 is preferably formed of a material having given heat resistance and elasticity. The elastic member P2 is formed of a resin material, such as rubber, polytetrafluoroethylene, or polyimide. Among these materials, rubber is preferably used since it has good elasticity, and silicon rubber that is excellent in the heat resistance, among various types of rubber, is particularly preferably used. The elastic member P2 may also be formed of an inorganic material (such as silicon) having a certain degree of elasticity. The inorganic material, which is excellent in the thermal conductivity, can heat an object to be welded, with higher efficiency.

The welding apparatus also includes a heating means and a moving means, in addition to the pressure plates P as described above. The heating means is a mechanism for heating the pressure plates. As the heating means, a known heater may be used without any particular restriction. The moving means is a mechanism for moving the pressure plates P toward each other and away from each other. With the moving means moving the pressure plates P closer to each other, an end portion of the laminated body 1A can be sandwiched between the pressure plates P and pressurized. Specific structures of the heating means and the moving means are not particularly limited provided that uniform and sufficient heat and pressure can be applied to the end portion of the laminated body 1A, and known structures can be employed with no particular restriction.

Welding of Exterior Film

According to the method of manufacture according to this embodiment, the welded portion W is formed by welding the outer peripheral portion of the exterior body 20, using the welding apparatus as described above. The method of manufacture includes a lamination step, placement step, heating step, and welding step. Each of the steps will be described below. As shown in FIG. 1, in the laminate battery 1 according to this embodiment, the welded portion W is formed in the outer peripheral portion of the exterior body 20. However, the terminal welded portion W2 is not formed in the welded portions W formed along the opposite side edges of the exterior body 20; therefore, a problem of “generation of a clearance in the vicinity of the step D at the boundary between the film welded portion W1 and the terminal welded portion W2” does not occur. Thus, description relating to formation of the welded portions W along the opposite side edges of the exterior body 20 will not be provided. The welded portions W extending along the opposite side edges of the exterior body 20 can be formed by a known method, and are not intended to restrict the technologies disclosed herein.

Lamination Step

In the lamination step, the constituent members of the laminate battery 1 as described above are stacked together, to form the laminated body 1A as a precursor substance of the laminate battery 1. More specifically, initially, the electrode body 10 with the electrode terminals 30 connected to its opposite end portions in the width direction X is prepared, and the thermally weldable films 40 are placed so as to cover surfaces of the electrode terminal 30. Then, the electrode body 10 on which the thermally weldable films 40 are placed is placed between the pair of exterior films 22, 24. In this manner, the laminated body 1A in which the electrode body is placed between the exterior films 22, 24 is formed. Then, the position of each member is adjusted, so that the end portions 34 of the electrode terminals 30 are exposed to the outside of the exterior films 22, 24. Thus, the exterior film 24, thermally weldable film 40, electrode terminal 30, thermally weldable film 40, and exterior films 22 are laminated in this order, in each end portion of the laminated body 1A.

Placement Step

As shown in FIG. 5, in the placement step, the end portion of the laminated body 1A as described above is placed between the pair of pressure plates P. At this time, it is preferable that the positions of the respective members are adjusted, so that a central portion of the laminated body 1A is aligned with central portions of the pressure plates P, in the depth direction Y. Thus, a more uniform pressure can be applied to the end portion of the laminated body 1A in the welding step that will be described later.

Heating Step

Then, in the heating step, the heating means of the welding apparatus operates to heat the pressure plates P to a given temperature. The temperature of the pressure plates P at this time is preferably set, in view of the welding temperatures of the exterior films 22, 24 and the thermally weldable films 40, and the thermal conductivity of the pressure plates P. As one example, the temperature of the pressure plates P is preferably set so that they can heat the exterior films 22, 24 via the elastic members P2, to a temperature within the range of 150° C. to 250° C.

Welding Step

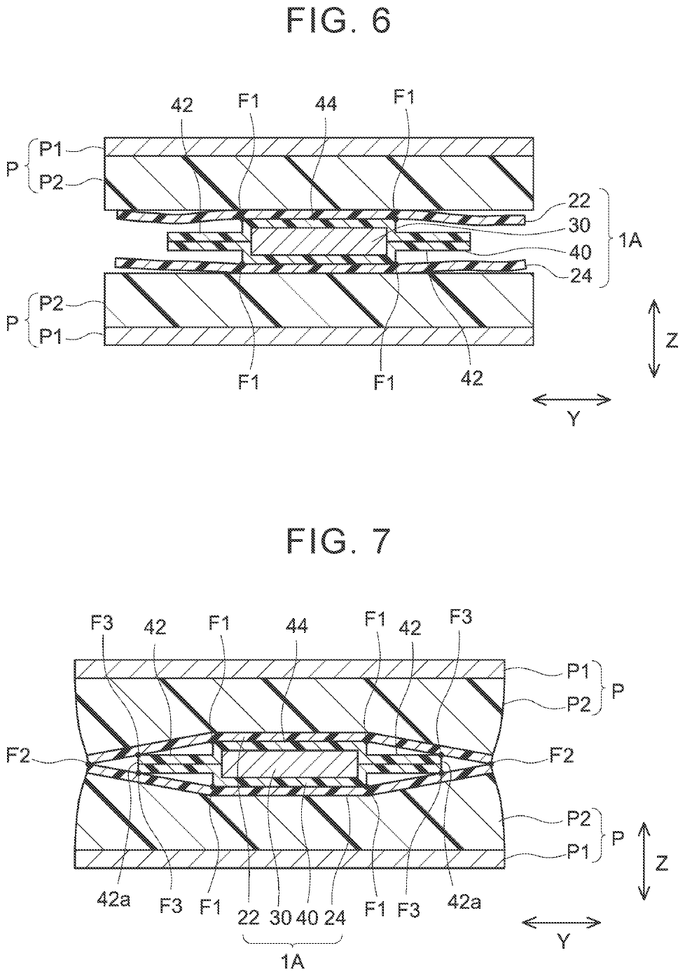

In the welding step, the end portion of the laminated body 1A is sandwiched between the pair of pressure plates P thus heated, to be pressurized and heated, so as to form the welded portion W that consists of the film welded portions W1 where the exterior films 22, 24 are welded to each other, and the terminal welded portion W2 where the exterior films 22, 24 are welded to the electrode terminal 30 (see FIG. 6 to FIG. 9). More specifically, the moving means of the welding apparatus is operated to move the upper and lower pressure plates P toward each other, and the end portion of the laminated body 1A is sandwiched between the pressure plates P, to be pressurized and heated. In this manner, the welded portion W that consists of the film welded portion W1 and the terminal welded portion W2 is formed.

In this embodiment, the length L_{P} of the protruding portion 42 of the thermally weldable film 40 is set to be equal to or larger than 50% of the thickness T_{E} of the terminal welded portion W2, and to be smaller than 100% of the length L_{F} of the film welded portion W1. With this arrangement, a clearance is prevented from being generated between the electrode terminal 30 and the exterior films 22, 24, in the vicinity of the step D at the boundary between the film welded portion W1 and the terminal welded portion W2. The reason why this effect is provided will be specifically described.

As shown in FIG. 6, when the pair of pressure plates P are moved toward each other in the welding step, the electrode terminal 30 comes into contact with the pressure plates P, via the exterior films 22, 24 and the thermally weldable films 40 (terminal covering portions 44). At this time, the exterior films 22, 24 are sandwiched between the opposite end portions of the electrode terminal 30 and the pressure plates P, and first fixed points F1 are formed. Then, when the pressure plates P are further moved toward each other, as shown in FIG. 7, the elastic members P2 of the pressure plates P are elastically deformed along the profile of the electrode terminal 30. At this time, the opposite end portions of the exterior films 22, 24 are sandwiched between the pressure plates P, and second fixed points F2 are formed. In this embodiment, the thermally weldable film 40 is formed with the protruding portion 42 having a sufficiently large length L_{P} that is equal to or larger than 50% of the thickness T_{E} of the terminal welded portion W2. Thus, at substantially the same time as formation of the second fixed points F2, the exterior films 22, 24 are sandwiched between the distal ends 42a of the protruding portions 42 and the pressure plates P, and third fixed points F3 are formed between the first fixed points F1 and the second fixed points F2.

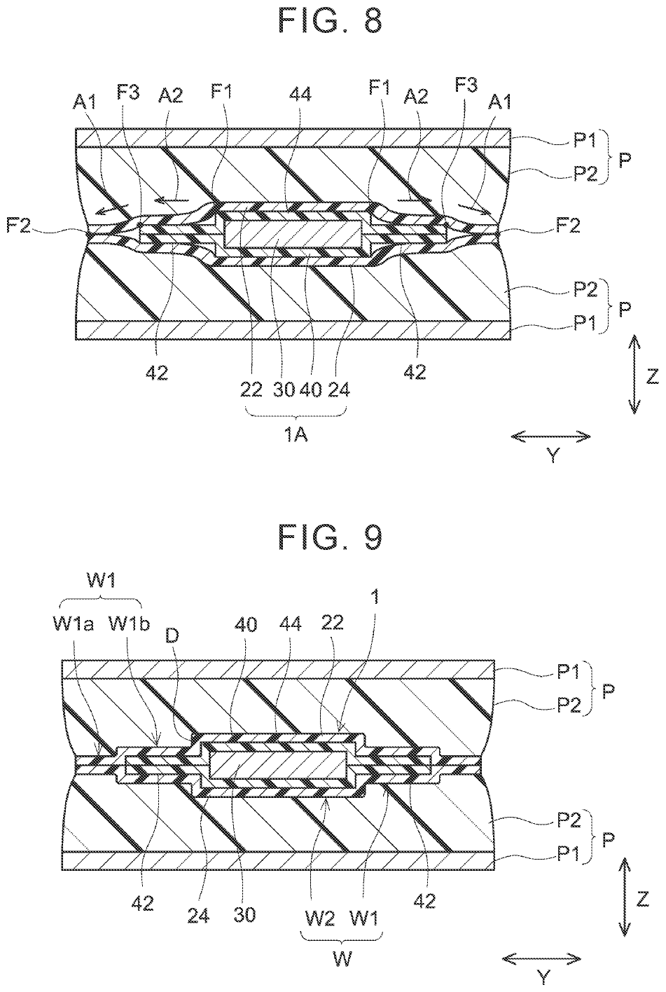

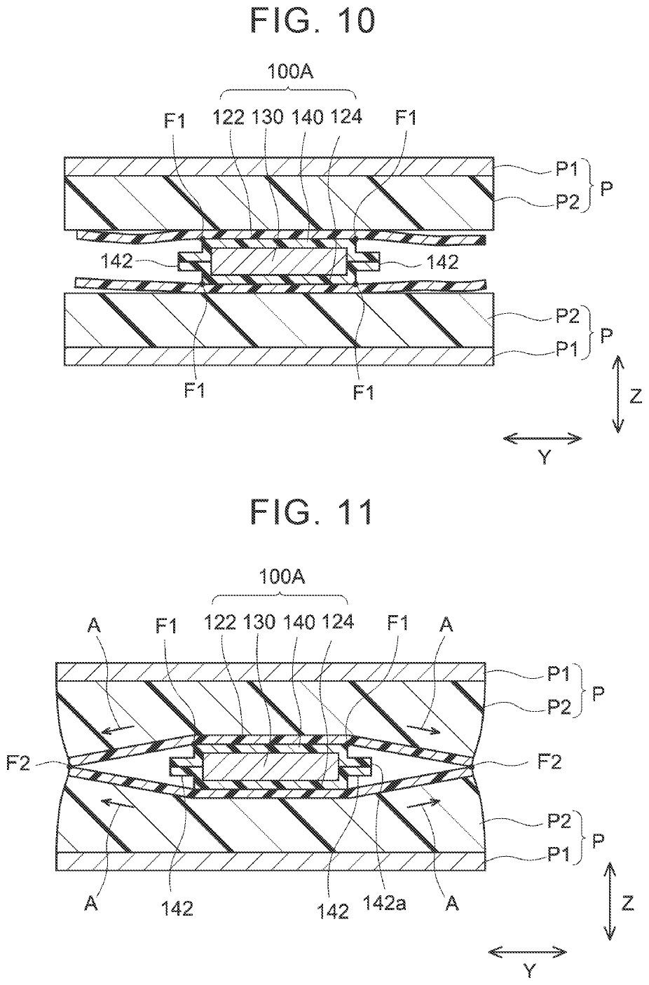

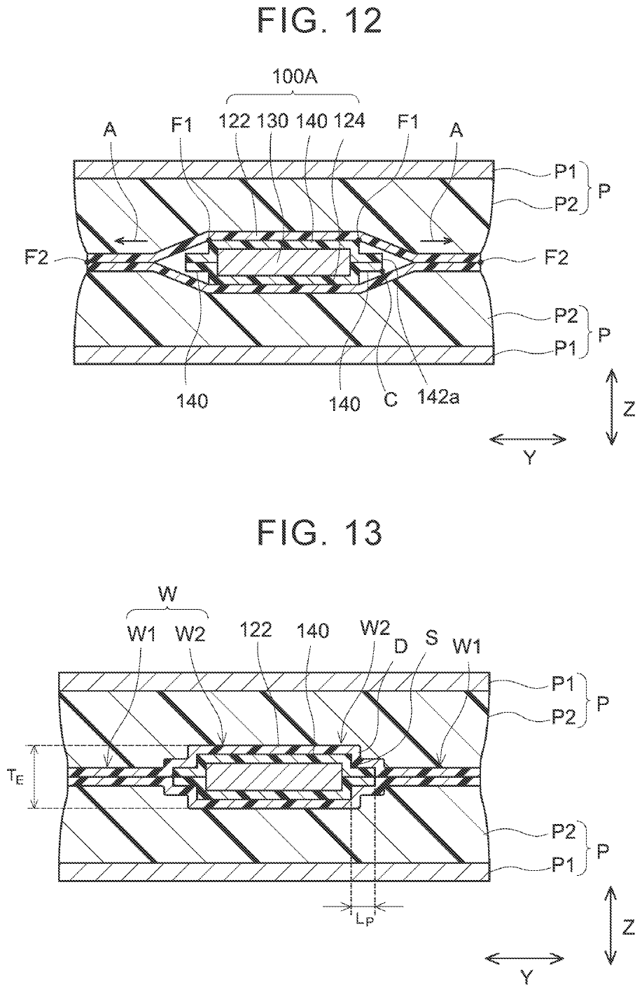

Then, when the pressure plates P are further moved toward each other, as shown in FIG. 8, the exterior films 22, 24 are pulled outward in the depth direction Y. In this embodiment, however, since the third fixed points F3 are generated between the first fixed points F1 and the second fixed points F2, tensile force applied to the exterior films 22, 24 is dispersed and reduced, as indicated by arrows A1, A2 in FIG. 8. Thus, the exterior films 22, 24 are prevented from being obliquely pulled with strong tensile force as in the related art (see FIG. 11 and FIG. 12). Thus, as shown in FIG. 9, it is possible in this embodiment to form the welded portion W while deforming the exterior films 22, 24 so as to follow the step D at the boundary between the film welded portion W1 and the terminal welded portion W2, and prevent a clearance from being formed between the exterior films 22, 24 and the electrode terminal 30 in the vicinity of the step D. Thus, according to this embodiment, it is possible to manufacture high-quality laminate batteries with high productivity, while favorably preventing reduction of the performance due to entry of water into the exterior body 20, volume expansion due to insufficient pressure reduction, and so forth.

Further, in this embodiment, the film welded portion W1 includes the first film welded portion W1a in which the exterior films 22, 24 are directly welded to each other, and the second film welded portion W1b in which the exterior films 22, 24 are welded to each other via the protruding portion 42 of the thermally weldable film 40. With this arrangement, the welded portion W is formed such that the thickness increases in steps from the opposite outer sides (the first film welded portions W1a) in the depth direction Y toward the middle portion (the terminal welded portion W2). Thus, the step D at the boundary of the film welded portion W1 and the terminal welded portion W2 is made smaller, which makes it easy to deform the exterior films 22, 24 so as to follow the step D. This point also contributes to prevention of a clearance in the vicinity of the step D.

Dimension of Each Member

In the laminate battery 1 disclosed herein, it is preferable to set the dimensions of the respective members, so that the second fixed points F2 and the third fixed points F3 are formed at times that are closer to each other, in the welding step as described above. For example, it is confirmed that generation of a clearance in the vicinity of the step D can be prevented, when the length L_{P} of the protruding portion 42 of the thermally weldable film 40 is equal to or larger than 50% of the thickness T_{E} of the terminal welded portion W2, as described above. However, the length L_{P} of the protruding portion 42 shown in FIG. 2 is preferably equal to or larger than 75%, more preferably equal to or larger than 100%, further preferably equal to or larger than 125%, particularly preferably equal to or larger than 150%, of the thickness T_{E} of the terminal welded portion W2. Thus, it is possible to make the time of formation of the second fixed points F2 further closer to the time of formation of the third fixed points F3, and favorably prevent generation of a clearance in the vicinity of the step D.

When the protruding portion 42 of the thermally weldable film 40 is excessively long, the distal end 42a of the protruding portion 42 is exposed to the outside of the exterior films 22, 24, and the third fixed points F3 are not formed. Thus, the length L_{P} of the protruding portion 42 of the thermally weldable film 40 is required to be smaller than 100% of the length L_{F} of the film welded portion W1. Considering that the time of formation of the second fixed points F2 is made closer to that of the third fixed points F3, it is preferable to adjust the length L_{F} of the film welded portion W1 so that the distal end 42a of the protruding portion 42 is located in the vicinity of a middle portion of the film welded portion W1. From this standpoint, the upper limit of the length L_{P} of the protruding portion 42 relative to the length L_{F} of the film welded portion W1 is preferably 90% or smaller, more preferably 85% or smaller, further preferably 75% or smaller, and is particularly preferably 65% or smaller. On the other hand, the lower limit of the length L_{P} of the protruding portion 42 relative to the length L_{F} of the film welded portion W1 is preferably 15% or larger, more preferably 25% or larger, and is further preferably 35% or larger.

The time of formation of the third fixed points F3 in the welding step tends to be earlier as the ratio of the thickness T_{P} of the protruding portion 42 to the thickness T_{E} of the terminal welded portion W2 is larger, and tends to be later as the same ratio is smaller. In view of this point, the thickness T_{P} of the protruding portion 42 shown in FIG. 2 is preferably equal to or larger than 5%, more preferably equal to or larger than 10%, further preferably equal to or larger than 15%, and is particularly preferably equal to or larger than 20% of the thickness T_{E} of the terminal welded portion W2. On the other hand, the thickness T_{P} of the protruding portion 42 is preferably equal to or smaller than 80%, more preferably equal to or smaller than 70%, further preferably equal to or smaller than 60%, and is particularly preferably equal to or smaller than 50% of the thickness T_{E} of the terminal welded portion W2.

While specific examples of the disclosure have been described in detail, the examples is merely illustrative, and are not intended to limit the appended claims. The technologies described in the claims include those obtained by modifying or changing the illustrated specific examples in various ways.

What is claimed is:

1. A laminate battery comprising:
an electrode body:
an exterior body having a pair of exterior films that are opposed to each other with the electrode body sandwiched between the exterior films;
an electrode terminal having a plate shape, and having a first end portion connected to the electrode body and a second end portion exposed to an outside of the exterior body, as viewed in a width direction; and
a thermally weldable film,
wherein the exterior body has a welded portion in an outer peripheral portion, the welded portion including a film welded portion in which the exterior films are welded to each other, and a terminal welded portion in which the exterior films are welded to the electrode terminal,
a surface of the electrode terminal disposed between the exterior films in the welded portion is covered with the thermally weldable film, and the thermally weldable film has a protruding portion that protrudes from a side face of the electrode terminal outward in a depth direction, and
a length of the protruding portion of the thermally weldable film is equal to or larger than 50% of a thickness of the terminal welded portion, and is smaller than 100% of a length of the film welded portion.

2. The laminate battery according to claim 1, wherein a thickness of the protruding portion is equal to or larger than 20% and equal to or smaller than 50% of the thickness of the terminal welded portion.

3. The laminate battery according to claim 1, wherein the length of the protruding portion is equal to or larger than 35% and equal to or smaller than 65% of the length of the film welded portion.

4. The laminate battery according to claim 1, wherein each of the exterior films is a laminate film having a multi-layer structure including at least a resin layer opposed to the electrode body, and a metal layer formed on an outer side of the resin layer.

5. The laminate battery according to claim 4, wherein one end portion of the thermally weldable film as viewed in the width direction is exposed to an outside of the exterior body.

6. A method of manufacturing a laminate battery including an electrode body, an exterior body having a pair of exterior films that are opposed to each other with the electrode body sandwiched between the exterior films, an electrode terminal having a plate shape, and having a first end portion connected to the electrode body and a second end portion exposed to an outside of the exterior body, and a thermally weldable film that covers a surface of the electrode terminal disposed between the exterior films, the method comprising:
forming a laminated body in which the electrode body to which the electrode terminal is connected is disposed between the exterior films, and the second end portion of the electrode terminal is exposed to an outside of the exterior films, while the surface of the electrode terminal disposed between the exterior films is covered with the thermally weldable film;
placing an end portion of the laminated body in which the electrode terminal is interposed between the exterior films, between a pair of pressure plates;
heating the pressure plates to a predetermined temperature; and
forming a welded portion by sandwiching the end portion of the laminated body between the heated pressure plates, to pressurize and heat the end portion, the welded portion including a film welded portion in which the exterior films are welded to each other, and a terminal welded portion in which the exterior films are welded to the electrode terminal,
wherein the thermally weldable film has a protruding portion that protrudes from a side face of the electrode terminal in a depth direction, and
wherein a length of the protruding portion is equal to or larger than 50% of a thickness of the terminal welded portion, and is smaller than 100% of a length of the film welded portion.
